(19) United States
(12) Patent Application Publication
(10) Pub. No.: US 2005/0194718 A1
(43) Pub. Date: Sep. 8, 2005

(54) Pipe liners and method of lining pipes

(76) Inventors: David John Blades, Sheffield (GB); Robert Jan Wiessner, Bladel (NL)

Correspondence Address: GOODWIN PROCTER L.L.P, 103 EISENHOWER PARKWAY, ROSELAND, NJ, 07068, US

(21) Appl. No.: 11/060,269

(22) Filed: Feb. 17, 2005

Related U.S. Application Data
(60) Provisional application No. 60/552,177, filed on Mar. 10, 2004.

(30) Foreign Application Priority Data
Feb. 17, 2004 (GB) 0403472.4

(51) Int. Cl. B29C 31/00; F16L 55/16

(52) U.S. Cl. 264/269; 138/98

(57) ABSTRACT

Provided herein are exemplary embodiments of novel and nonobvious liners, methods of lining passageways or pipelines using said liners, and uses of said liners. In one embodiment of the present invention, the liner comprises a resin absorbent material and a substantially impermeable coating. The substantially impermeable coating includes a modified polymer including a polymer having at least one additive incorporated thereto; wherein the dynamic coefficient of friction of the modified polymer is lower than the coefficient of friction of the polymer

### CROSS-REFERENCE TO RELATED APPLICATIONS

This application claims the benefit of priority to UK Application Number 0403472.4, filed Feb. 17, 2004 and U.S. Application No. 60/552,177, filed on Mar. 10, 2004, the entire disclosure of each is hereby incorporated by reference as if set forth at length herein.

### STATEMENT REGARDING FEDERALLY SPONSORED RESEARCH OR DEVELOPMENT

Not applicable

### REFERENCE OF A “MICROFICHE APPENDIX”

Not applicable

### BACKGROUND OF THE INVENTION

1. Field of Invention

The present invention relates, generally, to liners for pipes or passageways, such as underground passageways, and to methods of lining such passageways. More particularly, the invention relates to liners suitable for use in the cured in-situ or cured in position method of passageway lining.

2. Brief Description of the Prior Art

The cured in-situ method of lining passageways has proven to be a very successful method over the years and a considerable improvement over earlier lining techniques, such as techniques that use hard liners formed of preformed concrete segments, techniques that use liners with adhesives between the liner and surface or techniques that use a liner sheet formed of a plurality of plies bonded together into a laminated sheet. In essence, the cured in-situ method involves first, positioning the liner in the passageway to be lined and then, curing the liner in-situ such that the initially flexible liner is hardened within the passageway.

Conventionally, the in-situ method has used tubular liner lengths comprising a material that is able to absorb a resin, wherein such material is surrounded by a coating film of an impermeable material. Prior to insertion into the passageway requiring repair, the resin absorbent material is soaked in a curable resin. The liner is then introduced into the passageway before the resin is cured, i.e. the liner is introduced whilst it remains in a flexible condition. Once in place, the resin is cured, generally by the application of heat, such that the liner hardens to form a substantially rigid liner within the passageway. Moreover, once the liner has been inserted, it can be shaped to the dimensions of the passageway by the step of introducing air or water into the liner.

Although the method noted above is potentially useful for the lining of all passageways, it has proven particularly successful in the re-lining of underground sewers, and the like, where the liner can be used to re-line damaged sewers and thus prevent both leakage of sewerage out of the sewer, and leakage of ground-based water into the sewer, i.e. unwanted infiltration and/or exfiltration is reduced or prevented.

Clearly, an important step in the method of re-lining passageways as described above is the introduction of the liner into the passageway. Essentially, there are two main ways this can be achieved; either the liner can simply be dragged-in, see, for example, U.S. Pat. No. 4,009,063, the contents of which are incorporated herein by reference, or it can be inserted using an eversion technique, see, for example, U.S. Pat. No. 4,064,211, the contents of which are also incorporated herein by reference.

During the eversion technique, the liner, in the form of a tube, and comprising a coating on the exterior of a tubular member of resin absorbent material impregnated with a suitable resin, is introduced into a passageway at one end such that the coating and the tubular member evert as they progress into the passageway. In order to achieve the eversion, the tube is anchored at the passageway entrance and is then fed through the anchored end into the passageway so that the tube turns inside out, or everts, as it progresses into the passageway. As the tube everts, the coating presses the resin impregnated tubular member against the walls of the passageway. Moreover, fluid pressure is employed to move the tube comprising the coating and the resin impregnated tubular member along the passageway, and thus cause the tube to evert. The fluid pressure is conventionally and conveniently produced by at least partially filling the everting tube in the passageway with liquid, thus providing buoyant support. Suitably, the liquid can be water.

Alternatively, compressed air pressure can be used instead of liquid, i.e. water, pressure to cause the tube to evert. The main advantage of using compressed air over water pressure is that the speed of the lining process is not limited by the water flow; thus, inherently, it is a faster system.

However, all the aforesaid methods have certain drawbacks.

The drag-in technique requires the assembly and use of a pulley and winch system. This system can be costly to install and set-up times can be significant. Moreover, damage to the liner during drag-in insertion is a major problem, as is the inherent friction between the outer surface of the liner, i.e. the coating of the tubular member, and the surface of the passageway. This friction contributes to the likelihood of damage occurring to the liner during the insertion. Any damage caused to the liner can lead to the liner being rendered inoperable, increasing the time and costs of the lining process, as the damaged liner is removed and a new liner inserted.

The eversion technique generally allows larger diameter liners, and longer liner lengths, to be introduced in a single insertion stage. From a reduction in complexity and costs standpoint, this is an advantage. It is also advantageous with regards to reducing the set-up times and therefore costs for a given passageway length. Nevertheless, friction considerations remain a major problem, particularly the liner-on-liner friction, or more particularly, coating-on-coating friction, which becomes a major factor during eversion, even though liner-on-passageway friction, or more particularly, coating-on-passageway friction, remains a consideration.

Oil is conventionally used to reduce the friction and is typically applied by spray, by direct application to the coating of the tubular member, or by floatation of the oil in the water in the eversion tower. The application of oil is undesirable as it has both negative cost and environmental implications, and is generally a messy process, particularly when the oil is applied by spray. Moreover, the oil will circulate in the eversion fluid of a typical hot-cure water eversion system and can generate tar deposits which are found to be detrimental to the efficiency of the heat exchanger of the water heater.

As stated previously, a liquid, such as water, or compressed air, is used to enable eversion to proceed. The use of water provides buoyant support as well as an everting force, and is therefore preferred for larger diameter and/or longer length liners. Compressed air does not provide any buoyant support, but the fact that compressed air systems are generally quicker to install than water systems, means compressed air systems are generally preferred, particularly for smaller liner diameters/lengths. In either case, the presence of oil to reduce the friction associated with the eversion process is undesirable as it will either mix with the water, and subsequently enter into boiler and/or pumping equipment, or be sprayed into a fine oily mist by the compressed air. Both of these scenarios are environmentally undesirable.

Therefore, in addition to the problems noted above, the use of oil to reduce the mainly liner-on-passageway friction associated with the drag-in method, and the mainly liner-on-liner friction associated with the eversion method, leads to an environmentally-unfriendly, messy process, wherein the total and even coverage of the liner with the oil cannot be guaranteed, and the presence of the oil can prove detrimental to the operation of other machinery in the lining process, for example in the boiler used to produce the hot water required for the curing. Indeed, in an attempt to overcome this latter problem, detergents are often added to the water to assist removal of the oil, but this adds a further environmental consideration and costs to the process.

Clearly, it is desirable to be able to quickly and safely, i.e. without liner damage, line passageways as large as possible.

In view of the problems noted above, alternative methods have been prepared, such as the staged introduction technique described in U.S. Pat. No. 6,354,330 B1, herein incorporated by reference.

Nevertheless, there remains the need to produce liners which inherently possess physical characteristics which reduce the liner-on-liner friction, which causes major problems during eversion, and liner-on-passageway friction, which causes major problems during drag-in, and thus eliminate, or at least reduce, the necessity to use oil in the eversion or drag-in process. This is one object of the present invention.

One possible way of achieving the desired characteristics is to ensure the dynamic coefficient of friction [COF] of the coating film of the liner is as low as possible. This has led to the use of polymer coating films. Another possible way is to reduce the amount of liner in contact with itself (particularly helpful during eversion) or the passageway (particularly helpful during drag-in). Thus, previous attempts to alleviate the aforesaid problems have included embossing the coating material of the liner, generally a polymer coating. In effect, the surface of the liner polymer coating has a proportion raised or in relief from the surface, thus reducing the surface area of the liner polymer coating in contact with itself, or with the walls of the passageway to be lined. Although, this has some effect in reducing the COF of the liner coating, the improvements in the speed, cost and success of eversion and drag-in techniques are modest, and appreciable amounts of oil are still required.

Therefore, there remains the need for lining materials which preferably show improvements over those already known and preferably eliminate or at least alleviate some, if not all, of the problems in the art and/or outlined above.

### SUMMARY OF THE INVENTION

Provided herein are exemplary embodiments of novel and nonobvious liners, methods of lining passageways or pipelines using said liners, and uses of said liners. More specifically, in accordance with one aspect of the present invention there is provided a liner comprising: a resin absorbent material, and; a substantially impermeable coating; wherein the substantially impermeable coating comprises: a modified polymer including a polymer having at least one additive incorporated thereto; wherein the dynamic coefficient of friction of the modified polymer is lower than the coefficient of friction of the polymer.

According to another aspect of the present invention, the additive is at least one lubricant, at least one filler, or a combination thereof.

According to further aspect of the present invention, the polymer is selected from the group consisting of polythene, polystyrene, polyalkylenes, polyvinylchloride, polyvinylacetate, polytetrafluoroethylene, polyacetal, polymethylmethacrylate, styrene/acrylanitrile butadiene copolymer, phenol-formaldehyde resins, urea-formaldehyde resins, melamine-formaldehyde resins, epoxide resins, butyl rubber, epoxy resins, polyacrylics, polyamides, cellophane, neoprene, polyesters, and polyurethanes.

According another aspect of the present invention, the resin absorbent material is impregnated with a thermosetting resin.

According to a further aspect of the present invention, the substantially impermeable coating is between about 100 and about 1000 microns thick.

According to another aspect of the present invention, the additive is a lubricant selected from the group consisting of polyethylene waxes, oxidized polyethylene waxes, fatty acid waxes, fatty acid ester waxes, amide waxes, metallic fatty ester waxes, and fatty alcohol waxes.

According to a further aspect of the present invention, the additive is a filler selected from the group consisting of silicates, chrystobalite, nano-clays, talc, and diatomaceous earth.

According to another aspect of the present invention, the additive comprises a mixture of a lubricant and a filler.

According to a further aspect of the present invention, the additive is a lubricant included in an amount from about 0.1 to about 1.0% by weight in the modified polymer.

According to another aspect of the present invention, the additive is a filler included in an amount from about 0.5 to about 5.0% by weight in the modified polymer.

According to a further aspect of the present invention, the coating further comprises additional components selected from the group consisting of UV stabilizers, antioxidants, hydrolysis stabilizers, and pigments.

According to another aspect of the present invention, the coefficient of friction of the modified polymer is at least 10% lower than the coefficient of friction of the polymer.

According to a further aspect of the present invention, the coefficient of friction of the modified polymer is at least 40% lower than the coefficient of friction of the polymer.

According to another aspect of the present invention, the coefficient of friction of the modified polymer is less than about 2.0.

These and other aspects, features and advantages of the present invention will become better understood with regard to the following description, appended claims, and accompanying drawings.

### BRIEF DESCRIPTION OF THE DRAWING(S)

An exemplary embodiment of the present invention will now be briefly described with reference to the following drawing:

FIG. 1 depicts the results in graphical form of the variation in the COF versus the amount of amide wax lubricant/diatomaceous earth filler additive present in accordance with the teachings presented herein.

### DESCRIPTION OF THE INVENTION

The aspects, features and advantages of the present invention will become better understood with regard to the following description with reference to the accompanying drawing(s). What follows are preferred embodiments of the present invention. It should be apparent to those skilled in the art that the foregoing is illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

According to a first aspect of the present invention, there is provided a liner comprising a resin absorbent material, and a substantially impermeable coating, wherein said substantially impermeable coating comprises a modified polymer, and wherein said modified polymer comprises a polymer modified by the incorporation of at least one additive thereto, and wherein the dynamic coefficient of friction [COF] of the modified polymer is lower than the COF of the unmodified polymer.

Surprising and unexpected advantages have been found when coatings comprising such modified polymers were used to form liners, particularly considering the disadvantages of the prior art noted hereinbefore.

Accordingly, the liner is suitably flexible before insertion into the passageway to be lined, for example, sufficiently flexible to enable the liner to be inserted by either the drag-in or eversion technique described herein, more preferably sufficiently flexible to enable the liner to be inserted by the eversion technique.

Preferably, said modified polymer comprises, or is, a polymer modified by the incorporation of at least one lubricant, or at least one filler thereto, i.e. said at least one additive is at least one lubricant, or at least one filler. More preferably said modified polymer comprises, or is, a polymer modified by the incorporation of at least one lubricant, i.e. said additive is more preferably a lubricant. Alternatively, said modified polymer may comprise, or is, a polymer modified by the incorporation of at least one lubricant and at least one filler thereto.

By “incorporation”, we mean that the polymer has a further entity, preferably chemical entity, added to it, preferably during the process producing the modified polymer, which entity modifies the properties of the polymer to which it is added, more especially modifies the COF. Suitably, said entity is simply added to the other chemical ingredients in the required proportion, preferably during formation of the modified polymer. Suitably, said entity is thus included within the body of the polymer, thus forming the modified polymer.

Preferably, the liner is a continuous tubular lining, or at least a tubular liner of sufficient length that it can provide appropriate lengths for the lining of passageways in one continuous length. More preferably the tubular lining is at least 50 m in length, preferably at least 200 m in length, more preferably at least 300 m in length, even more preferably at least 500 m in length, most preferably at least 1000 m in length.

Preferably, the liner is no more than 5000 m in length, more preferably no more than 3000 m in length, most preferably no more than 2000 m in length.

Preferably, the diameter of the liner is between 5 cm and 250 cm, more preferably between 10 cm and 200 cm, most preferably between 20 cm and 150 cm.

Suitably, the liners of the invention can be used in the lining of any pipe or pipeline, or passageway in general, and the passageway may be underground or overground. Typically however, the liner is used for lining underground passageways, such as pipes.

Suitably, the resin absorbent material is bonded directly to the substantially impermeable coating by any convenient means. Preferably the layer of resin absorbent material is between 0.1-20 cm thick, more preferably between 0.2-15 cm, most preferably between 0.3-10 cm thick.

Preferably, the substantially impermeable coating is between 1 and 2500 microns thick, more preferably between 10 and 1300 microns thick, most preferably between 100 and 1000 microns thick.

Suitably, the polymer is selected from the list consisting of any suitable synthetic or natural polymer, such as polythene, polystyrene, polyalkylenes, for example polyethylene, polypropylene etc., polyvinylchloride, polyvinylacetate, polytetrafluoroethylene, polyacetal, polymethylmethacrylate, styrene/acrylanitrile butadiene copolymer, phenol-formaldehyde resins, urea-formaldehyde resins, melamine-formaldehyde resins, epoxide resin, butyl rubber, epoxy resins, polyacrylics, polyamides, cellophane, neoprene, polyesters, and polyurethanes, and the like, or mixtures of one or more of the above, and the like.

Preferably, the polymer is selected from the list consisting of polyethylene, polypropylene, polyvinylchloride, and polyurethanes.

More preferably, the polymer is a polyurethane.

Even more preferably, the polymer is a thermoplastic polyurethane characterized in that it has a melting point as determined by differential scanning calorimetry (DSC) of less than 230° C., preferably between 130° C. and 230° C. Yet more preferably, the polymer is an ester-based thermoplastic polyurethane, preferably with a melting point between 130° C. and 230° C., such as Estane® 58271, 58277, 54600, and 54610, as sold commercially by Noveon Inc.

Suitably, the resin absorbent material is any material which absorbs the resin, wherein the resin is the material that will be cured in-situ once the liner is inserted into the passageway, preferably a fibrous material such as a fibrous sheet structure, a non-woven or woven material or another flexible structure. As such, the fibrous material may comprise a mat or web of randomly oriented fibers which may be of glass and/or synthetic fibers. The fibers within the material can be of different denier.

More preferably, the resin absorbent material may comprise a non-woven polyester needlefelt material, wherein said material can be manufactured by any conventional needling processes.

A fibrous material comprising a needlefelt web or mat of randomly oriented fibers is found to be very suitable as a resin absorbent material. However, the absorption and subsequent carrying of the resin will be governed by both the thickness of the individual fibers in the resin absorbent material and the overall density of the fibrous material, and this will be readily appreciated by one skilled in the art.

The resin absorbent material acts as a carrier for the resin. Once the liner is in place, the resin can be cured by any convenient method, but usually the curing is effected by the heat provided from hot water passed through the entire length, or substantially the entire length, of the lining tube. Thus, the resin absorbent material essentially acts to keep the resin in a convenient and un-cured form until the liner is in place and the resin can then be cured, so that the then hardened thermosetting resin forms an ideal liner for passageways, such as sewers, by forming an effective barrier between the material flowing along the passageway and the passageway surface. As such, the initially flexible liner, for example, sufficiently flexible before insertion to allow insertion by either the drag-in or eversion techniques described herein, more preferably sufficiently flexible before insertion to allow insertion by the eversion technique, is hardened into an effective barrier by curing of the resin in the resin absorbent material.

Suitably, the resin absorbent material is impregnated with resin in a liquid, i.e. uncured, state such that when a liner according to the present invention has been introduced into the passageway to be lined, the resin is permitted to set and become hard by conventional means, i.e. is cured, such that a hard rigid resin pipe is formed within the passageway. Thus, the liner, typically initially sufficiently flexible to allow insertion into the passageway, i.e. before curing of the resin, once cured, forms a hard rigid resin pipe within the passageway.

Thus, according to a further embodiment of the present invention the resin absorbent material of the liner is impregnated with a settable or curable resin, i.e. a thermosetting resin, and preferably said impregnation occurs before the liner is introduced into the passageway to be lined, but in other embodiments said impregnation can occur during said introduction.

In effect, the resin absorbent material acts as a carrier for the resin, which resin eventually cures to form a hard lining, and the material keeps or retains the resin in a convenient form until it is cured. After the resin is cured it forms an ideal liner for passageways, forming an effective barrier between the material flowing along the passageway and the passageway itself.

Examples of suitable resins include epoxy resins and polyester resins. The resin can further comprise one or more additives, such as fillers, colorants and fire retardants.

The resin used is preferably a low exothermic resin, i.e. one which releases little heat upon curing.

Preferably, the substantially impermeable polymer coating is attached directly to the resin absorbent material.

Preferably, the substantially impermeable polymer coating covers substantially all of the outside surface of the resin absorbent material. As such, the substantially impermeable polymer coating will therefore lie between the resin absorbent material and the surface of the passageway being lined, where the liner is inserted into the passageway by the drag-in method. Conversely, when the eversion insertion technique is used, the resin absorbent material will lie between the substantially impermeable polymer coating and the surface of the passageway being lined. Alternatively, the liner can comprise two substantially impermeable polymer coatings, one covering substantially all of the outside surface of the resin absorbent material, the other covering substantially all of the inside surface of the resin absorbent material.

Suitably, the additive incorporated into the polymer to form the modified polymer, i.e. preferably the lubricant and/or filler, lowers the COF of the polymer compared to the COF of the polymer without the additive present, such that the COF of the modified polymer is lower than the COF of the unmodified polymer, preferably at least 5% lower, more preferably at least 10% lower, even more preferably at least 20% lower, yet even more preferably at least 40% lower, most preferably at least 60% lower. In effect, the additive will improve the movement of the polymer coating either against itself, of major benefit during the eversion technique, or against other materials, of major benefit during the drag-in technique.

More particularly, the COF of the polymer is lowered by the presence of the additive, such that the COF of the modified polymer is preferably lower than COF 2.0 when measured according to ASTM D1894 on a 400 μm thick film that has been coated on 170 g/m2 Kraft paper, more preferably less than 1.5, most preferably less than 1.

Alternatively, when measured on non-woven polyester to a weight of 900 g/m2, the COF should preferably be less than 2.0 when measured according to ASTM D1894, more preferably less than 1.0, and most preferably less than 0.5.

There are two main types of lubricants suitable for forming the modified polymers forming the substantially impermeable polymer coating(s) of the liner of an embodiment of the present invention; these are designated external lubricants and internal lubricants.

The former have only a limited degree of compatibility with the polymer and thus tend to migrate towards the surface of the polymer. As such, external lubricants tend to improve the surface appearance and gloss of polymers, in addition to reducing the COF of the polymer. Internal lubricants, on the other hand have a high degree of compatibility with the polymer, thus reducing the internal friction of the polymer. However, if the concentration of the internal lubricant exceeds its solubility constant in the polymer, the internal lubricant will additionally act as an external lubricant.

Generally, internal lubricants will have a higher degree of compatibility with the polymer matrix, than do external lubricants.

It is well understood by those skilled in the art that various classes of lubricants may demonstrate both internal and external lubricity, depending on the type of polymeric substance the lubricant is added to and the processing temperatures.

Suitable lubricants for use in forming the modified polymers of the present invention include natural waxes and oils, for example paraffins; synthetic waxes and oils, for example polyethylene and oxidized polyethylene waxes; fatty acids, for example C16- C18 acids, palmitic acids, stearic acids and oleic acids; fatty alcohols, which are derived from the corresponding fatty acids, for example cetyl and stearyl alcohol; fatty acid amides, for example monoamides, bisamides, and alkanolamides, such as oleamide and erucamide, ethylene bis-stearamide (EBSA) and ethylene bis-oleamide (EBOA). All of the aforementioned are predominately external lubricants.

Examples of predominately internal lubricants include metallic stearates, for example calcium stearates, zinc stearate, magnesium stearate, barium stearate, aluminum stearate, lead stearate, cadmium stearate, and lithium stearate; fatty acid esters, such as glycerol esters (e.g. glycerol monostearate), wax esters and other fatty esters.

Nevertheless, there are a wide range of lubricants that would be known to those skilled in the art and which could be used in liners of the present invention. In each case, it is important that the particular lubricant is compatible with the polymer and that the lubricant reduces the coefficient of friction of the polymer when forming the modified polymer.

Additionally, the polymer can be modified with a plurality of lubricants.

Preferred lubricants include polyethylene waxes, oxidized polyethylene waxes, fatty acid waxes, fatty acid ester waxes, amide waxes, metallic fatty ester waxes, and fatty alcohol waxes.

More preferred lubricants include oxidized polyethylene waxes, fatty acid waxes, fatty acid ester waxes, amide waxes, and fatty alcohol waxes.

Most preferred lubricants include oxidized polyethylene waxes, fatty acid ester waxes, and amide waxes.

Suitably, the lubricant is present in the polymer in an amount such that the COF of the modified polymer is lower than the coefficient of friction of the unmodified polymer, preferably at least 5% lower, more preferably at least 10% lower, even more preferably at least 20% lower, yet even more preferably at least 40% lower, most preferably at least 60% lower.

Preferably, the lubricant is present in the polymer in an amount between 0.01 and 5% by weight, more preferably between 0.05 and 3% by weight, even more preferably between 0.08 and 1.5% by weight, most preferably between 0.10 and 1.0% by weight, for example between 0.15 and 0.45% by weight.

Moreover, should more than one lubricant be present, the total amount of lubricants is preferably within these limits.

As stated hereinbefore, the substantially impermeable polymer coating of the liners of the present invention comprises a modified polymer comprising a polymer modified by the incorporation of at least one additive therein, preferably the incorporation of at least one lubricant, or at least one filler, or at least one lubricant and at least one filler, and furthermore wherein said additive is preferably dispersed homogeneously within the polymer structure.

The fillers (also known as “supporting additives”) suitable for use in the present invention are preferably selected from the list comprising silicates (for example, pyrogene, synthetic silica, mica-types, wallastonite, borax), chrystobalite, nano-clays (for example, montmorillonite clay), talc, and diatomaceous earth. The latter is particularly preferred and is a filler originating from plankton residue on the sea-bed.

Preferably, the filler is an inorganic material.

Such fillers can act as support in the polymer matrix, e.g. the polymer/lubricant matrix when a lubricant is also present. The fillers themselves can affect the COF values of the coatings and therefore, as stated hereinbefore, in one embodiment of the present invention, the modified polymer of the substantially impermeable coating may comprise a polymer modified by the incorporation of at least one filler thereto, either with or without the presence of at least one lubricant.

Suitably, the filler is present in the polymer in an amount such that the COF of the modified polymer is lower than the coefficient of friction of the unmodified polymer, preferably at least 5% lower, more preferably at least 10% lower, even more preferably at least 20% lower, yet even more preferably at least 40% lower, most preferably at least 60% lower.

Preferably, the filler is present in the modified polymer in an amount between 0.01 and 15% by weight, more preferably in the range 0.05 to 10% by weight, even more preferably between 0.1 and 7% by weight, most preferably in the range 0.5 to 5% by weight, for example between 0.9 and 2.75% by weight.

Moreover, should more than one filler be present, the total amount of fillers is preferably within these limits.

Previously, liners have been used wherein the substantially impermeable polymer coating comprises polyurethanes, polyvinylchlorides, polyethylene, and polypropylene. Each polymer has its own advantages. For example, the inherent COF of polyethylene and polypropylene layers is lower than polyurethanes. Conventionally, this has meant that the use of polyethylene and polypropylene layers in liners has been favored, particularly when using the drag-in insertion technique. However, despite having an inherently higher COF than either polyethylene or polypropylene, polyurethanes possess several advantages such that were it possible to reduce the COF of polyurethanes to a lower level, i.e. towards or even below that of unmodified polypropylene or polyethylene, the use of polyurethane layers in liners would be much preferred in the industry. The present invention makes such reductions possible.

The advantages of polyurethane layers in liners for passageways, over and above polypropylene or polyethylene layers, include the following: improved extensibility of the liner; improved flexibility of the liner; improved ease of repair of the liner; improved temperature resistance of the liner; improved abrasion resistance of the liner; and; improved hydrolysis properties of liner thus causing the impermeable layer to part from the resin absorbent material in small flakes so as to reduce the likelihood of passageway blockage, this being relevant when the liner is inserted by the eversion technique.

Preferably the modification of the polymer by the presence of the additive has no negative effect on these properties, more preferably the presence of the additive improves these properties still further, either when the additive is present in polyurethanes, or in other polymers in the substantially impermeable polymer coating.

Thus, the present invention enables passageways to be lined with liners comprising a polyurethane coating by reducing the COF of the coating to a level which overcomes its inherent disadvantage in COF compared to other available materials, whilst retaining the advantages of polyurethanes noted hereinbefore. Alternatively, the present invention reduces still further the COF of substantially impermeable polymer coatings which were hitherto considered to have relatively low coefficients of friction in any case, for example polyethylene and polypropylene coatings. In effect, the invention allows liners to be used which possess many exceptional properties but which conventionally suffer from relatively high inherent coefficients of friction, i.e. polyurethane coating based liners, or for a still further reduction in the COF values of coatings with relatively low inherent values, i.e. polyethylene or polypropylene based coatings.

Such improvements in lowering the COF of the polymer in the substantially impermeable polymer coating, and thus the frictional force encountered either coating-on-coating, or coating-on-surface of the passageway/machinery etc., enables liners to be introduced more safely, i.e. with less chance of damage to the liner, or larger liners to be introduced without increasing the likelihood of damage. Such an increased likelihood of damage would be inevitable without the present invention. The invention also enables the compressed air eversion insertion method to be used where previously, the water eversion insertion method had to be used, or was preferred. Moreover, the invention enables the use of a lubricant not integral to the coating, e.g. the adding of oil, such as vegetable oil, to be reduced or removed altogether. Yet still further, the invention allows the use of polymers in coatings that were not previously favored and could even have been considered unsuitable for certain liner sizes. Finally, the invention enables the whole of the coating to have a reduced COF, not the somewhat non-uniform reduction inherent via the addition of an oil via rollers, or the like. In essence, many of the problems of the prior art are addressed by the present invention.

The coatings of the liners of the present invention may further comprise additional components, particularly those compatible with the modified polymer, for example one or more components selected from the list consisting of UV stabilizers, antioxidants, hydrolysis stabilizers, pigments/colorants. Alternatively, no such additional components may be present.

In a second aspect of the present invention there is provided a method of lining passageways or pipelines wherein a liner is introduced into the cavity, for example the passageway or pipeline, to be lined and wherein said liner comprises a resin absorbent material, and a substantially impermeable coating, wherein said coating comprises a modified polymer, and wherein said modified polymer comprises a polymer modified by the incorporation of at least one additive thereto, preferably modified by the incorporation of at least one lubricant or at least one filler thereto, or modified by the incorporation of at least one lubricant and at least one filler thereto, and wherein the COF of the modified polymer is lower than the COF of the unmodified polymer.

Suitably, the resin absorbent material is impregnated before introduction into the cavity with a resin, preferably a settable or curable resin, more preferably a thermosetting resin, and preferably said resin is cured after said introduction such that the initially flexible liner becomes hardened. Nevertheless, said impregnation can occur during said introduction.

In a third aspect of the present invention there is provided the use of a liner comprising a resin absorbent material, and a substantially impermeable coating, wherein said coating comprises a modified polymer, and wherein said modified polymer comprises a polymer modified by the incorporation of at least one additive thereto, preferably modified by the incorporation of at least one lubricant or at least one filler thereto, or modified by the incorporation of at least one lubricant and at least one filler thereto, and wherein the COF of the modified polymer is lower than the COF of the unmodified polymer, in the lining of a passageway or pipeline.

For the avoidance of any doubt, it is herein stated that any or all of the features described above in relation to the first aspect of the present invention are equally applicable to the second and third aspects of the invention, unless any such features are mutually exclusive. In other words, the second and third aspects of the present invention may incorporate any one or more of the preferred features or embodiments of the first aspect of the invention, except of course where such features or embodiments are mutually exclusive or incompatible.

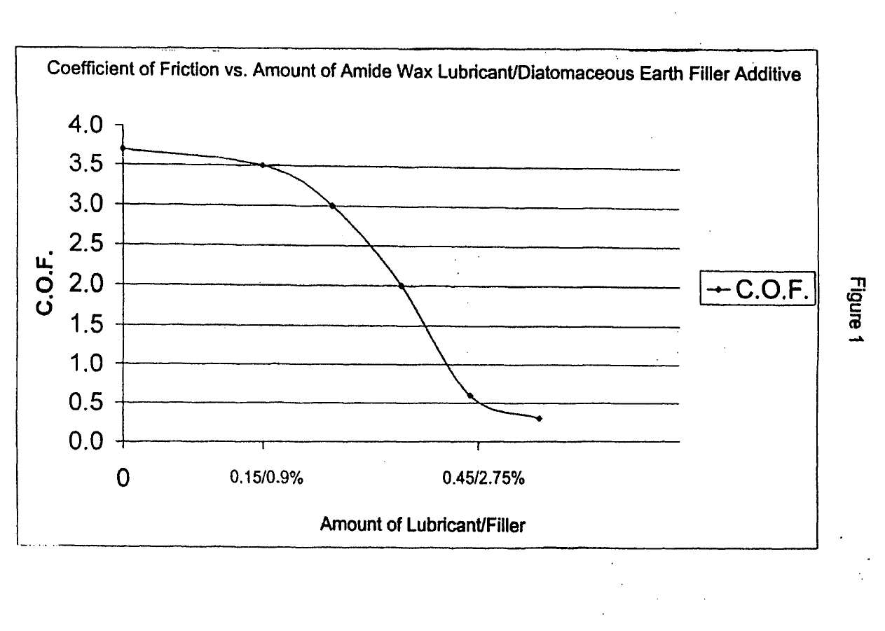

The present invention will now be described by means of the following illustrative and non-limiting examples and the accompanying drawing FIG. 1.

### EXAMPLE 1

### Modified Polymer

Various samples of Estane®, MC45DB1NAT021P, a thermoplastic polyurethane, was obtained from Noveon Europe B.V.B.A., Chausée de Wavre 1945, B-1160 Brussels, Belgium, wherein the thermoplastic polyurethane incorporated various levels of an amide wax lubricant additive, Glycolube VL, N—N′ ethylene bis stearamide (supplied by Lonza Group Ltd, Münchensteinerstrasse 38, Basel, Switzerland): 0.1%, 0.2%, 0.3%, 0.4%, 0.5% and 0.6% by weight with respect to the Estane®. Moreover, diatomaceous earth, Celite-Superfloss (supplied by Grupo Proquim, Centro Plaza Torre “B”, Piso 17 Av Francisco de Miranda Los Palos Grandes, Caracas 1060A—Venezuela) was dispersed in each sample as a filler/supporting additive: 0.5%, 1.0%, 1.5%, 2.0%, 2.5%, 3.0%, 3.5%, 4.0% by weight with respect to the Estane®. A further sample simply comprised Estane® MC45BD1NAT021P, i.e. with no Glycolube VL lubricant and no Celite-Superfloss filler additive.

The additives and filler/supporting additives were incorporated by adding in the required proportion.

FIG. 1 shows the results in graphical form of the variation in the COF versus amount of amide wax lubricant/diatomaceous earth filler additive. There is a clear decrease in the COF as the amount of lubricant/filler is increased, with the decrease being particularly marked between about 0.15%/0.9% ratio and 0.45%/2.75% ratio by weight of lubricant/filler.

Such polymer modified by such lubricant/additive combinations were used, together with resin absorbent material, to form liners of the present invention. Such liners were introduced into passageways in order to line said passageways.

### EXAMPLE 2

### Laboratory Coating and COF Measurement Set-Up

Two high gloss rollers of a ZKM600 laboratory melt coater [supplied by Kleinewefers Kunststoff Anlagen GmbH, Neuer Weg 24, D-47803 Krefeld, Germany] were heated to 170° C. and 180° C. for the back and front rollers, respectively. The coating speed was adjusted to 5 m/min.

A sample of 500 g of Estane® MC45DB1NAT021P was dried for 1 hour @ 110° C. in a tray. After cooling down to room temperature the thermoplastic polyurethane (TPU) was spread evenly between the two running rollers of the ZKM600 melt coater. The back roller ran at 4 m/min, the front roller at 5 m/min [friction ratio 20%].

The 500 g pre-dried Estane® MC45DB1NAT021P was left for at least 5 min to melt between the running ZKM600 rollers at a gap width less than 500 μm and more than 200 μm.

The roller speed and temperature differentials facilitated that a film of molten Estane® MC45DB1NAT021P formed on the front roller. During melting of the TPU the gap setting and pressure were set to accommodate a coating thickness of 400 μm thickness on 170 gr/m2 Kraft paper [supplied by Gelpa Verpakkingen, Delta 2, 6825MR Arnhem, The Netherlands]. As soon as a homogeneous melt formed between the rollers and a 400 μm uniform film of molten Estane® MC45DB1NAT021P ran on the front roller, the rubber take-off roller of the ZKM600 coating device, which carried the Kraft paper, was pressed mechanically against the front roller.

The process aid present in the TPU facilitated that the molten TPU film did not adhere to but is held by the hot front roller.

As soon as the Kraft paper touched the molten TPU film, the film adhered to the Kraft paper and was cleanly taken off the high gloss front roller of the ZKM600 device.

After a waiting time of at least 48 hours, a sample of the Kraft paper coated with 400 μm of Estane® MC45DB1NAT021P was prepared for COF testing according to the ASTM D-1894 method. A dynamic COF of 4.0+0.3 was measured, in the coating-to-coating mode. Other samples could be tested accordingly.

Although some preferred embodiments have been shown and described, it will be appreciated by those skilled in the art that various changes and modifications might be made without departing from the scope of the present invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

All publications mentioned herein are incorporated in their entirety by reference thereto.

1-28. (canceled)

29. A liner comprising:
a resin absorbent material, and;
a substantially impermeable coating;
wherein the substantially impermeable coating comprises:
a modified polymer including a polymer having at least one additive incorporated thereto;
wherein the dynamic coefficient of friction of the modified polymer is lower than the coefficient of friction of the polymer.

30. The liner as in claim 29 wherein the coefficient of friction is a dynamic coefficient of friction.

31. The liner as in claim 29 wherein the at least one additive is at least one lubricant, at least one filler, or a combination thereof.

32. The liner as in claim 29 wherein the polymer is selected from the group consisting of polythene, polystyrene, polyalkylenes, polyvinylchloride, polyvinylacetate, polytetrafluoroethylene, polyacetal, polymethylmethacrylate, styrene/acrylanitrile butadiene copolymer, phenol-formaldehyde resins, urea-formaldehyde resins, melamine-formaldehyde resins, epoxide resins, butyl rubber, epoxy resins, polyacrylics, polyamides, cellophane, neoprene, polyesters, and polyurethanes.

33. The liner as in claim 32 wherein the polymer is a polyurethane.

34. The liner as in claim 32 wherein the polyalkylene is polyethylene or polypropylene.

35. The liner as in claim 33 wherein the polyurethane has a melting point of between 130° C. and 230° C.

36. The liner as in claim 29 wherein the resin absorbent material is impregnated with a thermosetting resin.

37. The liner as in claim 29 wherein the substantially impermeable coating is between 100 and 1000 microns thick.

38. The liner as in claim 29 wherein the at least one additive is a lubricant selected from the group consisting of polyethylene waxes, oxidized polyethylene waxes, fatty acid waxes, fatty acid ester waxes, amide waxes, metallic fatty ester waxes, and fatty alcohol waxes.

39. The liner as in claim 29 wherein the at least one additive is a lubricant selected from the group consisting of oxidized polyethylene waxes, fatty acid waxes, fatty acid ester waxes, amide waxes, fatty alcohol waxes, and a combination of any of the foregoing.

40. The liner as in claim 29 wherein the at least one additive is a lubricant selected from the group consisting of oxidized polyethylene waxes, fatty acid ester waxes, amide waxes, and a combination of any of the foregoing.

41. The liner as in claim 29 wherein the at least one additive is a filler selected from the group consisting of silicates, chrystobalite, nano-clays, talc, and diatomaceous earth.

42. The liner as in claim 41 wherein the silicate is pyrogene, synthetic silican, mica-types, wallastonite, or borax.

43. The liner as in claim 41 wherein the nano-clay is montmorillonite clay.

44. The liner as in claim 40 wherein the at least one additive comprises a mixture of the lubricant and a filler selected from the group consisting of silicates, chrystobalite, nano-clays, talc, and diatomaceous earth.

45. The liner as in claim 41 wherein the at least one additive comprises a mixture of the filler and a lubricant selected from the group consisting of oxidized polyethylene waxes, fatty acid ester waxes, amide waxes, and a combination of any of the foregoing.

46. The liner as in claim 29 wherein the at least one additive is a lubricant included in an amount from about 0.1 to about 1.0% by weight in the modified polymer.

47. The liner as in claim 29 wherein the at least one additive is a filler included in an amount from about 0.5 to about 5.0% by weight in the modified polymer.

48. The liner as in claim 29 wherein the coating further comprises additional components selected from the group consisting of UV stabilizers, antioxidants, hydrolysis stabilizers, and pigments.

49. The liner as in claim 29 wherein the coefficient of friction of the modified polymer is at least 10% lower than the coefficient of friction of the polymer.

50. The liner as in claim 49 wherein the coefficient of friction of the modified polymer is at least 40% lower than the coefficient of friction of the polymer.

51. The liner as in claim 29 wherein the coefficient of friction of the modified polymer is less than about 2.0.

52. The liner as in claim 36 wherein said resin is substantially uncured and wherein the liner is sufficiently flexible such that the liner can be inserted into a passageway by the drag-in technique.

53. The liner as in claim 36 said resin is substantially uncured and wherein the liner is sufficiently flexible such that the liner can be inserted into a passageway by the eversion technique.

54. A method of lining a cavity of a passageway or pipeline, comprising: introducing a liner into the cavity; the liner comprising:
a resin absorbent material, and;
a substantially impermeable coating;
wherein the substantially impermeable coating comprises:
a modified polymer including a polymer having at least one additive incorporated
thereto;
wherein the dynamic coefficient of friction of the modified polymer is lower than the coefficient of friction of the polymer.

55. The method as in claim 54 wherein the coefficient of friction is a dynamic coefficient of friction.

56. The method as in claim 54 wherein the at least one additive is at least one lubricant, at least one filler, or a combination thereof.

57. The method as in claim 54 wherein the polymer is selected from the group consisting of polythene, polystyrene, polyalkylenes, polyvinylchloride, polyvinylacetate, polytetrafluoroethylene, polyacetal, polymethylmethacrylate, styrene/acrylanitrile butadiene copolymer, phenol-formaldehyde resins, urea-formaldehyde resins, melamine-formaldehyde resins, epoxide resins, butyl rubber, epoxy resins, polyacrylics, polyamides, cellophane, neoprene, polyesters, and polyurethanes.

58. The method as in claim 54 wherein the polymer is a polyurethane.

59. The method as in claim 57 wherein the polyalkylene is polyethylene or polypropylene.

60. The method as in claim 58 wherein the polyurethane has a melting point of between 130° C. and 230° C.

61. The method as in claim 54 wherein the resin absorbent material is impregnated with a thermosetting resin.

62. The method as in claim 54 wherein the substantially impermeable coating is between 100 and 1000 microns thick.

63. The method as in claim 54 wherein the at least one additive is a lubricant selected from the group consisting of polyethylene waxes, oxidized polyethylene waxes, fatty acid waxes, fatty acid ester waxes, amide waxes, metallic fatty ester waxes, and fatty alcohol waxes.

64. The method as in claim 54 wherein the at least one additive is a lubricant selected from the group consisting of oxidized polyethylene waxes, fatty acid waxes, fatty acid ester waxes, amide waxes, fatty alcohol waxes, and a combination of any of the foregoing.

65. The method as in claim 54 wherein the at least one additive is a lubricant selected from the group consisting of oxidized polyethylene waxes, fatty acid ester waxes, amide waxes, and a combination of any of the foregoing.

66. The method as in claim 54 wherein the at least one additive is a filler selected from the group consisting of silicates, chrystobalite, nano-clays, talc, and diatomaceous earth.

67. The method as in claim 66 wherein the silicate is pyrogene, synthetic silican, mica-types, wallastonite, or borax.

68. The method as in claim 66 wherein the nano-clay is montmorillonite clay.

69. The method as in claim 65 wherein the at least one additive comprises a mixture of the lubricant and a filler selected from the group consisting of silicates, chrystobalite, nano-clays, talc, and diatomaceous earth.

70. The method as in claim 66 wherein the at least one additive comprises a mixture of the filler and a lubricant selected from the group consisting of oxidized polyethylene waxes, fatty acid ester waxes, amide waxes, and a combination of any of the foregoing.

71. The method as in claim 54 wherein the at least one additive is a lubricant included in an amount from about 0.1 to about 1.0% by weight in the modified polymer.

72. The method as in claim 54 wherein the at least one additive is a filler included in an amount from about 0.5 to about 5.0% by weight in the modified polymer.

73. The method as in claim 54 wherein the coating further comprises additional components selected from the group consisting of UV stabilizers, antioxidants, hydrolysis stabilizers, and pigments.

74. The method as in claim 54 wherein the coefficient of friction of the modified polymer is at least 10% lower than the coefficient of friction of the polymer.

75. The method as in claim 74 wherein the coefficient of friction of the modified polymer is at least 40% lower than the coefficient of friction of the polymer.

76. The method as in claim 54 wherein the coefficient of friction of the modified polymer is less than about 2.0.

77. The method as in claim 61 wherein said resin is substantially uncured and wherein the introduction step further comprises inserting the liner into the cavity according to the drag-in technique.

78. The method as in claim 61 wherein said resin is substantially uncured and wherein the introduction step further comprises inserting the liner into the cavity according to the eversion technique.
